(19) United States
(12) Patent Application Publication
(10) Pub. No.: US 2004/0233172 A1
(43) Pub. Date: Nov. 25, 2004

(54) Membrane antenna assembly for a wireless device

(76) Inventors: Gerhard Schneider, Mex (CH); Daniel Bonanno, Geneva (CH)

Correspondence Address: FENWICK & WEST LLP, SILICON VALLEY CENTER, 801 CALIFORNIA STREET, MOUNTAIN VIEW, CA, 94041, US

(21) Appl. No.: 10/763,429

(22) Filed: Jan. 23, 2004

Related U.S. Application Data
(60) Provisional application No. 60/444,120, filed on Jan. 31, 2003.

(51) Int. Cl. G09G 5/00

(52) U.S. Cl. 345/168; 345/158

(57) ABSTRACT

A radio frequency keyboard assembly configured for use in a keyboard having a plurality of keys. The assembly includes a key matrix and a communication circuit. The key matrix includes an electrical matrix having switch points and a metallized membrane with printed geometric shapes that are part of an antenna. Each switch point is associated with a key from the plurality of keys and is capable of generating information associated with the key when the switch point connects with the electrical matrix. The antenna parts can be located on any surface of the membranes comprising the keyswitch matrix system. The communication circuit connects with the antenna and transmits the information through the antenna. To improve performance, RF signals can be transmitted when the switch points are not connected within the electrical matrix.

### CROSS REFERENCE TO RELATED APPLICATIONS

This application is related to and claims priority under 35 U.S.C. § 19(c) from U.S. Provisional Patent Application No. 60/444,120, filed on Jan. 31, 2003, entitled “Membrane Antenna Assembly for a Wireless Device” by inventors Gerhard Schneider, Sergio Lazzaroto, Viron Teodoridis, Daniel Bonanno, and Philippe Junod, said application having a common assignee, the contents of which are hereby incorporated by reference.

This application is related to co-pending U.S. patent application Ser. No. 10/112,285, filed on Mar. 29, 2002, entitled “Radio Frequency Keyboard Assembly,” by Junod et al., and which is incorporated herein by reference in its entirety. This application is also related to U.S. Pat. No. 6,507,763, issued on Jan. 14, 2003, to Schneider, et al. which is entitled “Antenna and Apparatus for Radio-frequency Wireless Keyboard” and which is a continuation of U.S. Pat. No. 6,138,050, issued on October 24, both of which are incorporated herein by reference in their entirety.

### BACKGROUND OF THE INVENTION

1. Field of the Invention

The present invention relates to wireless keyboards for use in a data processing system and, more specifically, to antennas for wireless keyboards for use in a data processing system.

2. Description of the Related Art

Conventional RF cordless devices include an RF transmitter and an antenna that is used to propagate RF signals from the device to an antenna and receiver combination (typically called a “receiver”) connected with, for example, a host computer system. Particularly, cordless devices used in combination with personal computers or workstations include RF transmitters and antennas that, for user convenience, are typically enclosed within the common enclosures of such devices, for example, inside keyboards, mice, cameras, keypads, and the like. In the past, most conventional RF cordless computer peripherals operated at relatively high frequencies in the range of 2.4 gigahertz (“GHz”) that ensured a strong RF signal connection between the conventional RF cordless device and the receiver connected with the host computer system. The higher frequency ranges provided stronger RF signal strength to ensure the RF link does not drop between the conventional cordless keyboard and the host computer system. They also require smaller antenna lengths. However, the higher frequency systems require more power leading to a shorter battery life and the circuitry for such higher frequency devices are complex and expensive. These drawbacks translate in higher cost and inconvenience for the user.

To reduce circuit complexity and cost, as well as increase battery life, conventional RF cordless devices are also designed to operate at a lower RF frequency ranges, for example, under 100 MHz. For example, today, some conventional RF cordless keyboards are designed to operate in a 27 MHz range or a 40-49 MHz range. The 27 MHz range is gaining greater acceptance among wireless computer peripherals as other wireless devices and applications are moving to operating in the ultra high frequency (“UHF”) range. This causes less crowding in the 27 MHz range and thus there are less chances of interference between devices.

A problem with a device operating in the 27 MHz range is that it requires a much larger antenna to provide an effective RF link. For example, a conventional RF cordless keyboard operating in a 27 MHz range may ideally require a dipole antenna of 5.5 meters or a whip antenna over a ground plane of 2.75 meters in length. An antenna of either length would be impracticable in view of the dimensions of the conventional RF cordless keyboard. Therefore, the conventional antenna in a conventional RF cordless device operating in a 27 MHz range is smaller in length, and hence, is less efficient. In turn, this limits the range of freedom for a user, because the maximum distance between the conventional RF cordless device and the receiver connected with the host computer system is significantly limited.

Yet another problem with a conventional antenna in conventional RF cordless devices is the location of the antenna within the enclosure of the conventional RF cordless device. The placing of the antenna must be carefully planned and the antenna must be assembled to avoid interference with other metallic portions, for example, in a keyboard, the key matrix within the keyboard may interfere with RF signals. This increases design, manufacturing and test costs that increase overall product cost for the RF cordless devices.

Hence, there is a need for an antenna in a cordless device and other confined spaces that (1) helps increase antenna efficiency, (2) helps reduce power consumption, (3) reduces sensitivity from internal components within the device or confined space, and (4) decreases overall design and manufacturing cost structures.

### SUMMARY OF THE INVENTION

The present invention includes a membrane keyswitch matrix assembly configuration for wireless or cordless devices that comprises an antenna that is configured on one or more surfaces of membranes in the keyswitch matrix assembly or system. Further, to improve communication performance, in one embodiment of the present invention a communication circuit in the keyswitch matrix transmits radio frequency (“RF”) signals by loading the RF signals onto the antenna when there are no closed circuits within an electrical matrix in the keyswitch matrix assembly.

The present invention also includes a radio frequency keyboard assembly for use in a cordless (or wireless) keyboard or like device that has, for example, six or more keys (e.g., a 2×3 key matrix). The keyboard assembly includes a keyswitch matrix assembly, a processing system, an antenna, and a communication circuit. The keyswitch matrix assembly couples with the communication circuit. The communication circuit couples with the antenna.

The keyswitch matrix assembly is configured for placement within the enclosure of the wireless device, for example, within the plastic case of a keyboard. The keyswitch matrix assembly includes an electrical matrix that includes two or more rows and columns of conductive material on several membrane layers. At the intersection of each row and column is a switch point. Each switch point is associated with a key of the keyboard. Generally, the electrical matrix is an open circuit. However, when a key is pressed, the switch point couples the associated row and column within the electrical matrix to create continuity and closes the circuit to generate a signal associated with the key pressed. When the key is released the electrical matrix once again is an open circuit.

The processing system, which scans the electrical matrix for closed circuits, locates the closed circuit and generates information associated with the key. The communication circuit uses the information generated from the processing system and generates a corresponding radio frequency signal. In one embodiment, the communication circuit couples with the antenna to transmit the radio frequency signal when no switch points in electrical matrix form a closed circuit.

The antenna of the present invention may be configured from a conductive material or printing substance (e.g., conductive ink, metallic trace, or the like) and is configured in a geometric shape on a surface of anyone of the membranes or layers of the keyswitch matrix assembly. The antenna may be a loop antenna configuration and the loop may be configured along an outer-most edge of the keyswitch matrix assembly to increase the length for loop. Moreover, the antenna may be configured along at least two planes to help increase the length of the loop. The antenna may include components printed on the membrane surfaces coupled to other elements, for example wires, to increase the overall loop size. The printed elements or geometric shapes can form a ground plane that connected to the antenna improves the overall transmission performance.

The present invention may advantageously incorporate the electrical matrix for a keyboard and the antenna within the keyswitch matrix assembly. This provides a benefit of providing a low cost keyswitch matrix assembly for a cordless keyboard, by including an antenna that can be printed on the membrane layers during the keyswitch matrix manufacturing process at a lower cost than an independently manufactured antenna. The printed elements can contribute to produce a loop antenna with a large loop length that allows for using a lower frequency communication circuit, e.g., operating at a range of 27 MHz, within the cordless device. The lower frequency communication circuit helps reduce power consumption, helps increase battery life, and helps reduce design, manufacturing, and use costs for the cordless keyboard.

The features and advantages described in this specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 illustrates one embodiment of a radio frequency keyboard for use with a host computer system in accordance with the present invention.

FIG. 2 is a diagram illustrating a computer keyboard in accordance with the present invention.

FIG. 3 is a diagram illustrating an internal structure of a wireless keyboard in accordance with the present invention.

FIG. 4a illustrates one embodiment of layers of a keyswitch matrix in accordance with the present invention.

FIGS. 4b and 4c illustrate a first and a second embodiment for a keyswitch matrix assembly in accordance with the present invention.

FIG. 5 is a diagram of a modified keyswitch membrane with printed antenna components according to one embodiment of the present invention.

FIGS. 6a, 6b, and 6c are diagrams illustrating different embodiments of loop antennas comprising a metallized membrane according to the present invention.

FIGS. 7a, 7b, and 7c are diagrams illustrating alternative embodiments of loop antennas comprising a metallized membrane according to the present invention.

FIGS. 8a, 8b., and 8c are diagrams illustrating different embodiments of antennas comprising a metallized membrane according to the present invention.

FIG. 9a, 9b, and 9c illustrate embodiments layers in a keyswitch matrix assembly membrane system having printed antenna components in accordance with the present invention.

FIG. 10 illustrates one embodiment of a process for transmitting radio frequency signals in accordance with the present invention.

FIG. 11 illustrates one embodiment of a process for receiving radio frequency signals in accordance with the present invention.

### DETAILED DESCRIPTION OF THE INVENTION

The Figures (“FIG. ”) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in the accompanying drawings. It is noted that wherever practicable similar or like reference numbers may be used in the figures and may indicate similar or like functionality. Embodiments of the present invention that include antennas configured with a keyswitch matrix assembly and a cordless (or wireless) keyboard or like system comprising a keyswitch matrix assembly including an antenna are used for descriptive purposes. However, the same principles herein described are applicable to other wireless devices such as, wireless mice, digital cameras (still and video), joysticks, game pads, and the like.

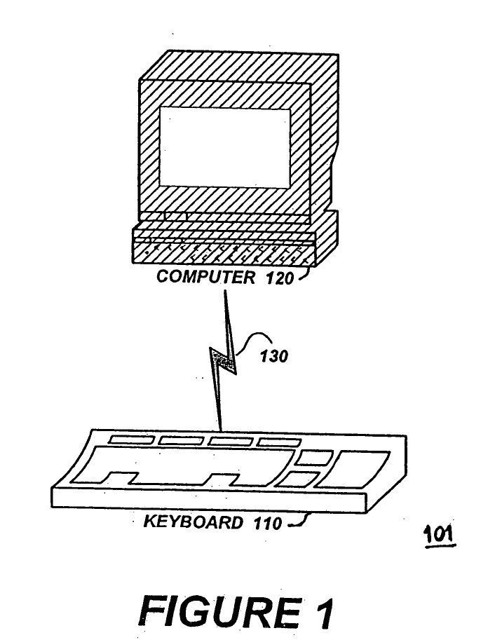

FIG. 1 illustrates one embodiment of a data processing system 101 comprising a radio frequency (“RF”) keyboard 110 for use with a processor system 120 (or host computer system) in accordance with the present invention. The RF keyboard 110 communicates through a wireless communication link 130 with the host computer. The wireless communication link 130 may be a RF link that operates at any frequency, although preferentially at a frequency of under 100 megahertz (“MHz”), e.g., approximately a 27 MHz range, such as 27.045 MHz to 27.145 MHz.

The host computer system 120 is a conventional host computer system, for example, a personal computer, a workstation, or a game station. The host computer system 120 includes a RF receiver (uni-directional communication) or a RF transceiver (bidirectional communication) for coupling through the wireless communication link 130 with the RF keyboard 110.

The RF keyboard 110 is a conventional RF keyboard for communicating with the host computer system 120, for example, inputting data through keystrokes. The RF keyboard 110 is representative of other wireless or cordless device, for example, wireless mice, cameras, or the like. The RF keyboard 110 may have a RF transmitter (uni-directional communication) or a RF transceiver (bi-directional communication) for coupling through the wireless communication link with the RF keyboard 110.

The RF keyboard 110 may have a conventional keyboard layout, for example, a 82-key, 101-key, a 104-key, or a 108-key QWERT keyboard layout, an ergonomic keyboard, or the like, and may have conventional keyboard dimensions, for example, 35 to 50 centimeters (“cm”) in length by 15 to 20 cm in width by 2 to 6 cm in height. In another alternative embodiment the RF keyboard may have smaller dimensions, for example, 6 to 9 cm in length by 9 to 15 cm in width by 1 to 4 cm in height or may be a keypad, for example, a keypad for use with a payment system, a credit card magnetic reader, a palm size computer, a scanner, wireless data input units, or the like.

Alternatively the RF keyboard 110 may have a conventional keypad or game pad layout, for example, a 10-key or 12-key numerical and/or symbol keypad layout, and may have conventional keypad dimensions, for example, 100 to 200 mm in length by 90 to 180 mm in length by 20 to 60 mm in height. In addition, in further alternative embodiments, the RF keyboard 110 may have wave, convex, or concave layouts, e.g., for ergonomic purposes. For ease of discussion, the RF keyboard 110 will be described as a bi-directional communication 101-key keyboard.

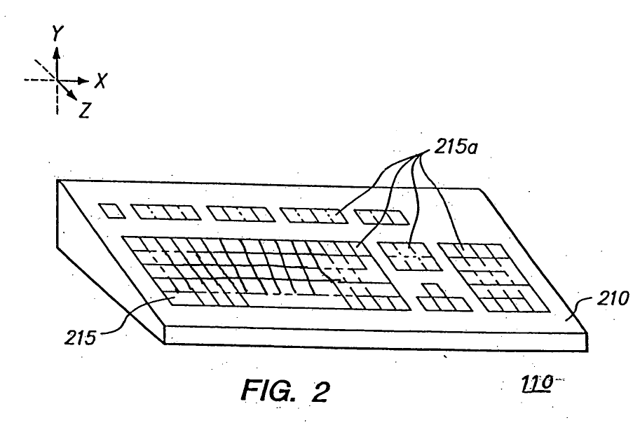

FIG. 2 is an external diagram of one embodiment of the wireless keyboard 110 in accordance with the present invention. The wireless keyboard 110 having a housing 210 and a keycap subsystem 215 that includes one or more keycaps 215a. The housing 210 may be composed of a plastic, for example an injection molded thermoplastic or other similar material. Further, the keycaps 215a may also be composed of a thermoplastic material.

It is noted that the keyboard function of the wireless keyboard 110 may be functionally and structurally similar to a commercially available keyboard such as, for example, a 101-key keyboard from IBM Corporation of Armonk, N.Y., a wave keyboard from Microsoft Corporation, of Redmond, Wash., any of the cordless keyboards from Logitech, Inc., of Fremont, Calif., or any other similar commercially available keyboard. In addition, the dimensions of the wireless keyboard 125 may be approximately 46 centimeters by 18 centimeters by 3 centimeters, for example. As previously noted, a keyboard embodiment is used by way of example but other wireless devices such as mice, numeric key-pads, hand-held computers, cameras, or the like, of different dimensions and shapes can equally be used in conjunction with the invention described herein.

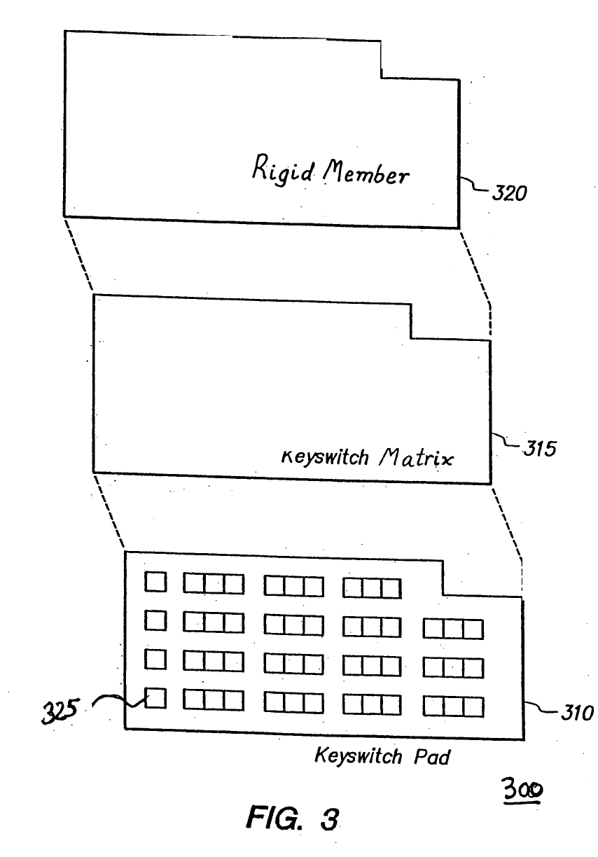

Now referring to FIG. 3a, a diagram illustrates the internal structural components of a keyswitch system 300 for use in a wireless device such as the wireless keyboard 110. The keyswitch system 300 includes a keyswitch pad 310, a keyswitch matrix subsystem 315 that may include one or more keyswitch printed circuit membranes or printed circuit board layers, and an optional rigid member 320, for example, a metallic plate, a rigid plastic plate, or the like. The keyswitch pad 310 includes keyswitches 325 that are, for example, membrane keyswitches, mechanical keyswitches, or the like. The keyswitch pad 3110 may be integrated with the keyboard keys 215 or with the keyswitch matrix subsystem 315 so that the switching is done in the keyswitch matrix subsystem 315 upon pressing on the keys 215. The keyswitch matrix subsystem 315 is, for example, a printed circuit board (“keyswitch PCB”), a printed circuit membrane (“keyswitch PCM”), or the like. It is noted that in a keyswitch PCB embodiment, the rigid member 320 may not be necessary because if rigidity is required for switching, it can be provided by the PCB itself, which generally has a very limited range of flexibility. In addition, any function provided by a metallic plate embodiment of the rigid member 320 can be substituted with a similarly functioning element such as for example, a thin copper film, a conductive ink imprint, or the like, as further discussed below.

The keyswitch pad 310 and the keyswitch matrix subsystem 315 may be comprised of a lightweight flexible plastic or other similar material. Typically, the keyswitch matrix subsystem 315 in a keyswitch PCB embodiment comprises one or more layers of a substrate material that is substantially rigid (low Z-axis, or vertical, expansion), e.g., FR-4 or other epoxies (BT), resins, polyamides, or the like. The circuit connections are generally made of a deposited metal, e.g., gold, forming contacts for component placement, trace connections, and vias to interconnect layers. Typically, vias are drilled, for example, mechanically, with a laser, or the like. A passivation layer or film electrically insulates the traces leaving only exposed contacts for components, connectors, and the like.

In a membrane type keyswitch matrix 315, the layers (e.g., top layer 420a, bottom layer 420b, collectively 420, and the key switch mechanism layer 430) are typically configured from a flexible substrate material, for example, film membrane, flexible polymer, a fabric, plastic rubber, or the like that is very flexible in all axis, including the Z-axis. Preferably, the keyswitch PCM, are made of substantially flexible materials for both the membrane layers and the conductive traces and contacts comprised in the circuitry thereon. Flexible materials for the traces, contacts, and the like include flexible wire, conductive ink, tape wire, or the like. Keyswitch PCMs can be thinner, lighter weight, and cheaper than PCB alternatives. In addition, flexible keyswitch PCMs are more versatile and can be used in a wider range of enclosures of different shapes and sizes, for example, in the top convex portion of a mouse, in keyboards that are not flat in one single plane but instead convex or concave keyboards, e.g., ergonomic keyboards, specialty keyboards, or the like. Further, interlayer connections may be simpler to produce during manufacturing. However, in some embodiments the membrane layers may be substantially rigid, e.g., rigid plastic, and conductive traces on the membrane layers, whether flexible or not, may also be substantially rigid, e.g., metallic trace, wire, or the like. Typically, the keyswitch matrix subsystem 315 is configured in size to have a perimeter that is substantially the interior perimeter of the wireless device, for example, the perimeter of the RF keyboard 110.

The rigid member 320 may be comprised of a metallic material that is substantially rigid and may have dimensions of 40 centimeters by 15 centimeters, for example. Each keyswitch 325 is associated with a particular keycap 215 that is, in turn, associated with a particular character or function on the wireless keyboard 110.

The keyswitch pad 310 is coupled to the keyswitch matrix subsystem 315. The combination of the keyswitch pad 310 and keyswitch matrix subsystem 315 may be coupled to the optional rigid member 320, which provides structural rigidity for the keyswitch system 300 of the wireless keyboard 110. The rigid member 320 can also protect the keyswitch matrix subsystem 315 against electrostatic discharge.

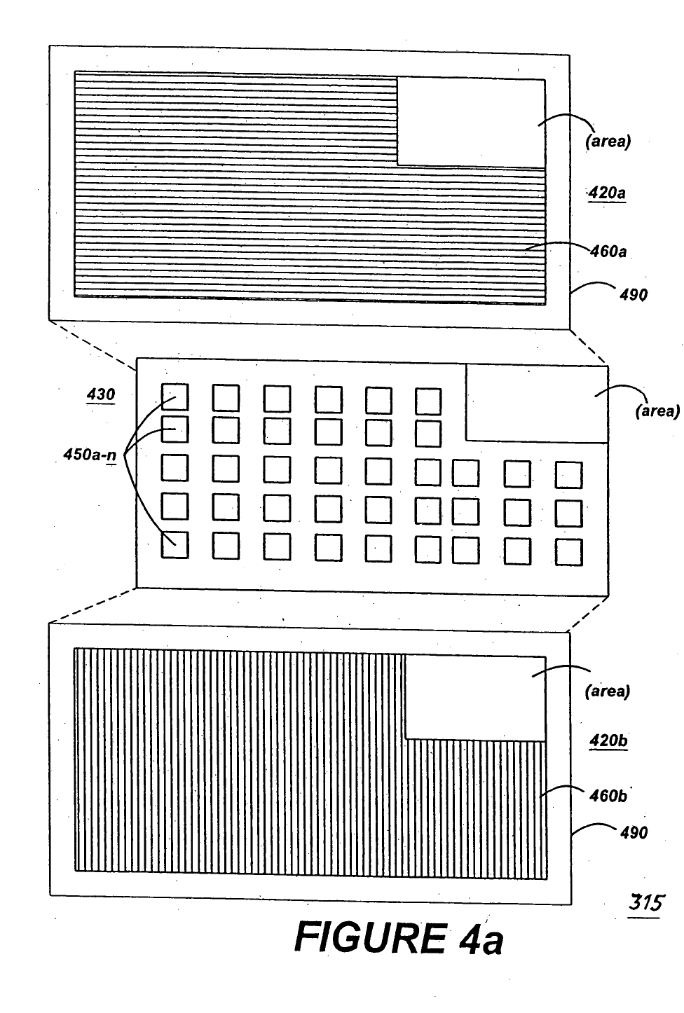

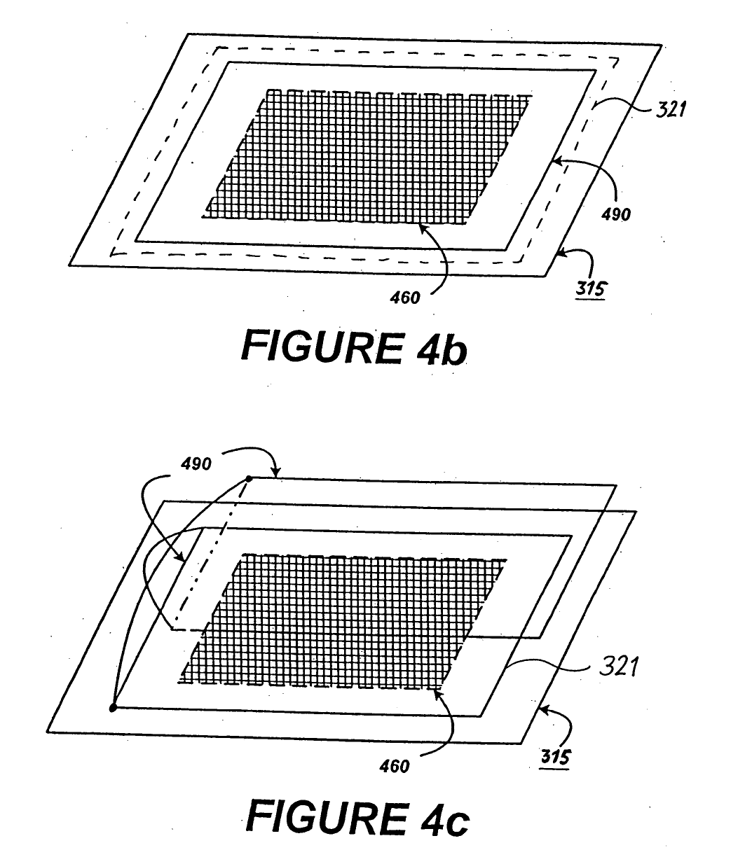

FIG. 4a illustrates one embodiment of layers of a keyswitch matrix subsystem 315 in accordance with the present invention. The keyswitch matrix subsystem 315 includes a series of electrical contacts. Each electrical contact is in an open position until closed by a particular keyswitch 325. A keyswitch 325 closes the electrical contact when a user depresses the associated key-cap 215. As further described below, the RF wireless keyboard 125 transmits an RF signal corresponding to the character or function associated with the particular keycap 215 and keyswitch 325 to an RF receiver subsystem associated with a host computer 120. The RF signal can be digitally encoded with information identifying the character or function or may use modulation scheme to convey an identification of the corresponding character or function.

The keyswitch matrix subsystem 315 includes a set of key matrix layers 420 and one or more keyswitch mechanism layers 430. For example, a first layer 420a includes conductive rows 460a, a second layer 420b includes conductive columns 460b, which collectively make up a conductive electrical matrix 460. The conductive rows and columns may be made up of traces, either deposited or printed, or small wires, e.g., tape wire. Further, the keyswitch matrix subsystem 315 may include a single keyswitch mechanism layer 430 to selectively isolate the rows 460a from the columns 460b. The keyswitch mechanism layer 430 can be configured to have openings at contact points 450 such that when the keyswitch matrix subsystem 315 is assembled in a keyboard 110, the contact points 450 are located under each of the keyboard keys 215.

The key matrix layers 420 and keyswitch mechanism layers 430 may be separate layers or may be integrated together into an electrical matrix 460. In a separate layer configuration the key matrix layers 420 or the keyswitch mechanism layers 430 may be separated into additional layers, for example, a first layer may include rows for an electrical matrix 460a and a second layer may include columns for the electrical matrix 460b or alternatively, both layers can include both rows and columns for an electrical matrix 460. In addition, it is noted that if a flexible material is used for the keyswitch matrix subsystem 315, a rigid member 320, for example, a rigid polymer, may be used as backing to provide additional structural support within the RF keyboard 110.

The key switch mechanism layers 430 may be a conventional mechanism, for example, a rubber dome mechanism, a metal contact mechanism, a membrane mechanism, a foam element mechanism, or a capacitive mechanism, that electrically couples conductive rows 460a to columns 460b in separate key matrix layers 420. The keyswitch mechanism layers 430 can be in the keyswitch pad 310 as discussed above or implemented with a set of membrane layers in the keyswitch matrix subsystem 315 actuated directly by the keys 215 in the keyboard 110.

The key matrix layers 420 and the keyswitch mechanism layers 430 make up the electrical matrix 460. The electrical matrix 460 may be a grid of circuitry that includes two or more rows 460a and two or more columns 460b of electrical lines or traces. Each intersection of a row 460a and a column 460b of the electrical matrix 460 is configured to lie under a key on the keyboard and forms a switch point 450 that is closable with key pressure. The key matrix layers 420 also include at least part of an antenna 490. The components (parts or elements) of the antenna 490 may be on any one or more surfaces of any one or more of the membranes in the keyswitch matrix subassembly 315. In accordance with the present invention, the parts or elements of the antenna 490 may also be printed with conductive printing substances, such as, metallic inks. The membranes printed with the metallic ink will be referred to as a metallized membranes 321, that is, a metallized membrane 321 is a membrane having a top side or surface an a bottom side or surface that has a geometric structure printed on either or both sides with a conductive ink. For ease of manufacturing, both, the electrical matrix 460 and the parts of the antenna 490 located on the metallized membranes 321 can be made with the same process, for example, depositing metallic trace or wire, printing with conductive ink, or a combination thereof.

A metallized membrane 321 is printed with or coated with a conductive printing substance, i.e., a metallic or conductive ink or paint. Conductive inks or paints are known in the art, they include any ink containing conductive particles that make a resulting imprint that conducts electricity, e.g., currents due to or corresponding to electromagnetic energy. The coating or printing can be done in any way conductive inks can be used, for example, spinning, screen printing, ink jet printing, or the like. The metallized membrane 321 is printed with a pattern that may be utilized for its electrical characteristics to form part of a circuit, for example, an antenna 490 circuit. These geometric shapes or patterns may include entire surfaces, polygonal surfaces, loops, grids, spirals, dipoles and other shapes used to change the operating parameters of the particular antenna 490. One skilled in the art will recognize the design choices involved in choosing a pattern or geometric shape, and that any such pattern is suitable for use with the present invention.

The antenna 490 may be configured as a loop antenna, e.g., along a substantially outer perimeter or edge of a metallized membrane 321, or in a spiral printed geometric shape on the top surface of the top key matrix layer 420a (metallized membrane 321) to provide a large antenna loop length. FIG. 4b illustrates a conceptual view of one embodiment of a keyswitch matrix subsystem 315 in accordance with the present invention. The key switch matrix subsystem 315 includes the electrical matrix 460 and an antenna 490 along an outer portion of a metallized membrane 321 in the keyswitch matrix subsystem 315. The metallized membrane 321 may be any one of the layers 420/430 in the keyswitch matrix subsystem 315 or several of them coupled together to form the antenna 490.

In addition, the antenna 490 may also be configured to extend into a second geometric plane apart from the geometric plane of the keyswitch matrix subsystem 315. FIG. 4c illustrates a conceptual view of another embodiment of a keyswitch matrix subsystem 315 in accordance with the present invention. This embodiment includes the electrical matrix 460 and an antenna 490 having a portion or component extending to a separate geometric space than the one occupied by the metallized membrane(s) 321. For example, a first portion or component of the antenna 490 may be on a metallized membrane 321 and the second portion or component of the antenna 490 may be coupled with or extended from the first portion or component of the antenna 490 in a separate plain that may be parallel to the first portion or component of the antenna 490. It is noted that the second portion or component of the antenna 490 may be, for example, a conductor wire or an antenna wire electrically coupled to the geometric shape printed in the metallized membrane 321.

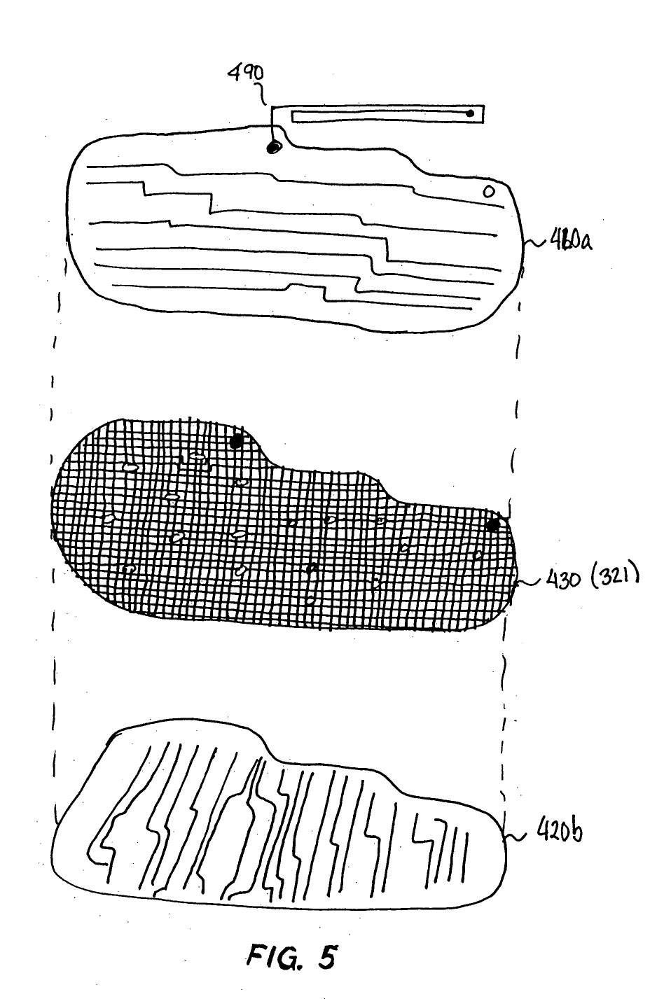

In addition, one embodiment of the keyswitch matrix subsystem 315 includes other antenna components printed in one or more metallized membranes 321. FIG. 5 shows an antenna 490 that includes a conductive plane printed by entirely coating the top side of the keyswitch mechanism layer 430 (metallized membrane 321) with a conductive ink. Since the conductive plane is on the top side of the keyswitch mechanism layer 430, it does not cause a short circuit in the lower layer 420b, and since the top layer 420a only has conduction points located “above” the switch points 450 in the keyswitch mechanism layer 430, there is no potential for shorting the top layer 420a by coming in contact with the conductive ink. Conductive planes, such as for example ground planes, are typically connected to antennas to improve performance of the radio frequency transmissions. These conductive planes can be made in several ways, for example, with metallic plates, coated printed circuit boards, printed membranes, and the like. In one embodiment of the present invention, a conductive ground plane is printed with conductive ink on a surface of a metallized membrane 321.

As noted above, in one embodiment, the top side of the keyswitch mechanism layer 430 may be fully covered with a conductive ink or paint. In another embodiment, the top side of the keyswitch mechanism layer 430 may be printed with an ink-saving pattern which approximates the effects of a completely coated surface, for example, a closely spaced grid of lines as illustrated in FIG. 5. In both embodiments, such a coated surface forms a flexible conductive plane, which may be used as part of the antenna 490. The function of this conductive plane is similar to the metallic plate 320 used in other RF keyboard antennas, for example, the one described in U.S. Pat. No. 6,507,753, which is assigned to the same assignee as the present invention and is incorporated herein by reference in its entirety.

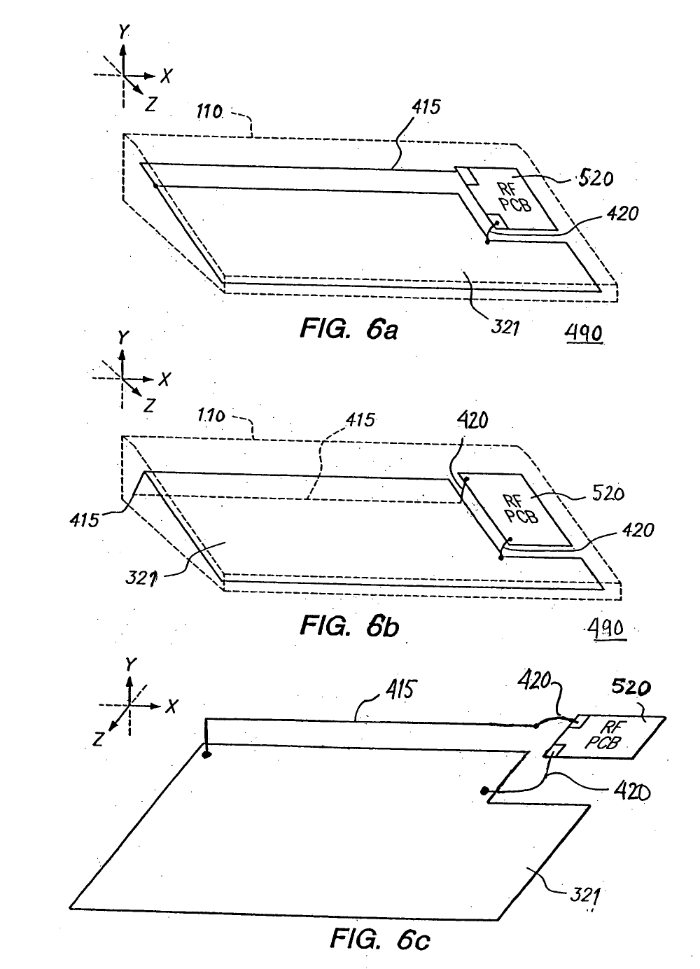

As noted above, the antenna 490 may be a loop antenna. FIG. 6a, 6b, and 6c are diagrams illustrating different embodiments of loop antennas 490 comprising a metallized membrane 321 according to the present invention. The loop antenna 490 includes the metallized membrane 321, an antenna wire 415, and a connector wire 420. For clarity, the metallized membrane 321 is shown as a substantially rectangular depiction (321), however, as described above, the metallized membrane can have a printed geometric shape or pattern in any side and any one or more layers of a keyswitch matrix 315 may be a metallized membrane 231. Further, the metallized membrane 321 is not limited to a keyswitch matrix 315 layer, but rather, it can be any surface internal to a wireless device on which metallic ink can be coated, printed, or otherwise deposited. Additionally, in these Figures, the actual pattern or shape printed in the metallized membrane is not shown. For example, the metallized membrane 321 may be printed with a tightly spaced grid that has similar electrical characteristics to those of a metallic plate as shown in FIG. 5.

An RF unit 520 can be considered part of the loop antenna 490 or it may be considered a separate element to which the loop antenna 490 connects as discussed below. An RF unit may include a transmitter or transceiver that couples to the antenna and to other components of the wireless device, for example, a controller for the keyswitch system 300. Referring now to FIG. 6a, the antenna wire 415 is coupled at a first end to an input/output (I/O) port of an amplifier in the RF unit 520 and is coupled at a second end to a first end or section (contact point or terminal) of the metallized membrane 321. A second end or section of the metallized membrane 321 is coupled, through the connector wire 420, to a second I/O of the amplifier, which may be an electrical ground for the RF unit 520.

The antenna wire 415 and the metallized membrane 321 form an antenna loop that is coupled to the outputs of the RF unit 520 with one or more connectors 420, e.g., connecting wires or traces. The length of the antenna loop may be approximately equivalent to the length of the wireless keyboard 110 and the width of the antenna loop may be as large as the remaining free space (height, length, and/or width) within the wireless keyboard 110. For example, the antenna loop may have a length of 40 centimeters and a width of 2 centimeters. In alternative embodiments the length and/or the width of the antenna loop may be enlarged or shortened.

The loop antenna 490 generates a magnetic field from which the RF signals from the RF unit 520 are transmitted to a receiver subsystem associated with the data processing terminal or host computer 120 in accordance with known electromagnetic propagation principles. The space between the antenna wire 415 and the metallized membrane 321 provides a large antenna loop surface for transmitting the RF signals. As discussed above, the fully enclosed loop antenna advantageously enables the operation of wireless keyboards at lower frequencies, for example in the 27 MHz frequency band, without having a large cumbersome antenna interfering with the user's space.

It is noted that in one embodiment of the present invention, the loop antenna 490 includes an antenna wire 415 having one turn. In an alternative embodiment of the present invention, the antenna wire 415 may have more than one turn. The additional turns of the antenna wire 415 expands the surface area of the antenna loop to increase the transmission range of the loop antenna 490. Further, it is noted that in alternative embodiments of the present invention the antenna loop may lie in the same geometric plane as the metallized membrane 321 as shown in FIG. 6a or in any other plane, for example, as shown in FIGS. 6b (bellow) and 6c (above). The antenna wire 415 can be directly connected to the RF unit 250, as shown in FIG. 6a, or connected through a connector 420, as shown in FIGS. 6b and 6c.

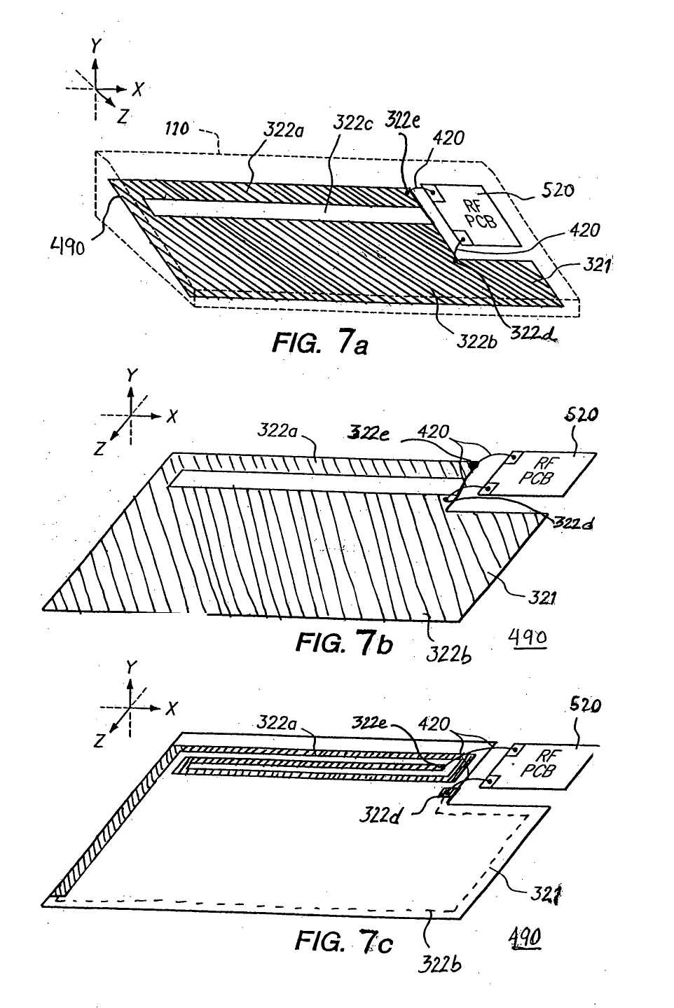

FIG. 7a is a diagram of a second embodiment of a loop antenna 490 within the RF wireless keyboard 110 in accordance with the present invention. FIG. 7b is a standalone diagram of the second embodiment of the loop antenna 490 in accordance with the present invention. In FIGS. 7a, 7b, and 7c, the shape or pattern printed on the metallized membrane 321 is shown as the dashed surface area. It should be noted that the actual lines used in these Figures do not necessarily correspond to lines of conductive ink in the actual metallized membrane 321. The lines shown in the Figures are only intended to illustrate the overall contour of the area in which the shapes or patterns can be printed, for example, with conductive ink. It is further noted that the antenna 490 of FIG. 7a is functionally equivalent to the antenna 490 of FIG. 6a, however, the antenna wire 415 has been eliminated and replaced by a different shape printed on the metallized membrane 321 that has the same electrical characteristics as they relate to the performance of the antenna 490.

Thus, the RF antenna 490 shown in FIGS. 7a, 7b, and 7c include alternative embodiments of a metallized membrane 321 having printed geometric shapes or patterns for one or more parts or elements of the loop antenna 490. For example, FIG. 7a shows a first antenna portion or component 322a and a second antenna portion or component 322b. In addition, the RF unit 520 is coupled to the metallized membrane 321 through connectors 420, e.g., wires, traces, or the like. The first antenna portion or component 322a and the second antenna portion or component 322b are printed the same metallized membrane 321 and form a cut-out space 322c in-between. One I/O of the amplifier in the RF unit 520 is coupled using a connector 420 to the first antenna portion or component 322a. The second I/O of the amplifier in the RF unit 520, which may be the electrical ground of the RF unit 520, is coupled to the second antenna portion or component 322b. The connectors 420 can be coupled to the metallized membrane at contact points 322d and 322e. Contact points 322d and 322e can be printed with conductive ink or otherwise deposited with any conductive material that enables a connection with connectors 420, for example, bonding or soldering metal pads for wire bonds or other wires or traces.

An antenna loop is formed by the geometry of the shapes imprinted as the first antenna portion or component 322a and the second antenna portion or component 322b on the metallized membrane 321. Once again, the length of the antenna loop may be approximately equivalent to the length of the wireless keyboard 110 and the width of the antenna loop may be as large as the remaining free space (height, length, and/or width) within the wireless keyboard 110. The antenna loop may lie in any plane as described above with respect to FIGS. 6a, 6b, and 6c.

The cut-out space 322c between the first antenna portion or component 322a and the second antenna portion or component 322c is part of the surface of the metallized membrane 321 that is not printed with conductive ink when the shape or pattern is formed. The cut-out space 322c can provide for a large antenna loop length for transmitting RF signals. Further, the geometries on the metallized membrane 321 may be printed to include more than two antenna portions to form a cut-out space having two or more turns as illustrated in the first antenna portion or component 322a shown in FIG. 7c. Further, it should be noted that the portions or elements of the antenna 490 need not be printed in the same side of metallized membrane 231, for example, in FIG. 7c dashed line 322b illustrates a printed trace or second antenna portion or component 322b in the back side of metallized membrane 321. In addition, the antenna portions can be printed on different layers of the keyswitch matrix 315. For example, a first portion or component can be printed in the bottom side of the top membrane layer 420a and the second antenna component 322b can be printed in the keyswitch mechanism membrane 430 in a shape or pattern such that the two portions only overlap in a contact point.

As described above, the additional turns and antenna components expand the length of the antenna loop to increase the transmission range of the antenna 490. In addition, the versatility of location and distribution of printed antenna components in different sides and layers of the keyswitch matrix subsystem 315 provides flexibility of design to improve the performance of the RF transmissions without increasing the overall physical space occupied by the circuitry. This feature is beneficial in size-constrained devices such as wireless keyboards, mice, keypads, and the like where space is limited but a large antenna loop is desirable for transmissions in frequencies under 100 MHz, e.g., in the 27 MHz range. Further, the flexibility of the metallized membrane 321 allows the incorporation of antennas 490 into wireless devices with non-conventional enclosures, for example, in convex or concave keyboards or other curved keyboard designs (e.g., for optimal ergonomic use or for improved aesthetic appeal), in foldable keyboards, or the like.

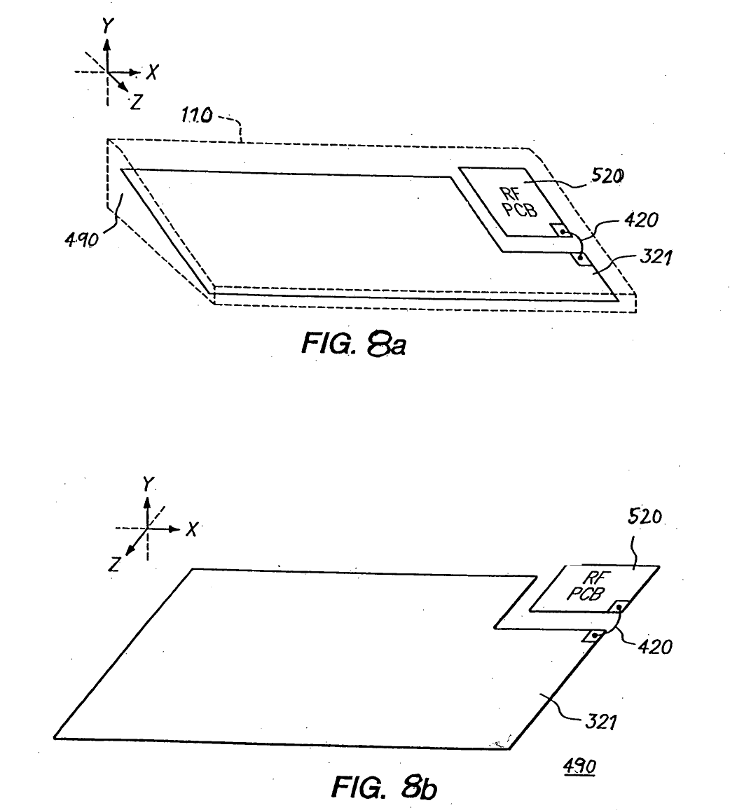

FIG. 8a is a diagram of a third embodiment of an antenna 490 within the RF wireless keyboard 110 in accordance with the present invention. FIG. 8b is a standalone diagram of the third embodiment of the antenna 490. It is noted that the antenna 490 shown in this embodiment is similar to the antenna 490 shown in FIGS. 7a, 7b, and 7c, so that a large order antenna size is not required to transmit RF signals in lower frequency bands, for example in the 27 MHz frequency band, from the RF unit 520 of the wireless keyboard 110.

The antenna 490 includes a third embodiment of a metallized membrane 321, the RF unit 520, and the connector 420. It is noted that the third embodiment of the metallized membrane 321 is similar to the metallized membrane 321 shown in previous Figures with respect to, for example, serving as part of the antenna 490 while preventing electrostatic discharge. The output of the amplifier in the RF unit 520 is coupled through the connector 420 directly to the metallized membrane 321. There is no ground connection between the metallized membrane 321 and the RF unit 520. In this embodiment, the antenna 490 includes the metallized membrane 321 operating as a whip or dipole antenna. The whip antenna of the antenna 490 generates an electric field from which RF signals are transmitted to a receiver subsystem associated with a host data processing system 120 in accordance with electromagnetic propagation principles. As in the previous embodiments, the metallized membrane 321 may include any geometric shape or pattern design that meets the requirements for optimal antenna performance, for example, a polygonal surface, a grid pattern, a dipole, a spiral, or the like.

According to another aspect of the present invention, a wireless device may implement a time-sharing procedure to ensure that the electromagnetic fields of the keyswitching functions and the antenna 490 do not interfere with each other. Examples of such procedures are described in full in co-pending U.S. patent application Ser. No. 10/112,285 incorporated herein by reference in its entirety. In general terms, a controller restricts the transmission of RF signals while a user is pressing keys or buttons associated with a keyswitch matrix subsystem 315 according to the present invention. By restricting the transmission of RF signals from times of keyswitching activity, the amount and degree of interference between the two uses of the keyswitch system 300 is minimized, or at least easily recognized as interference.

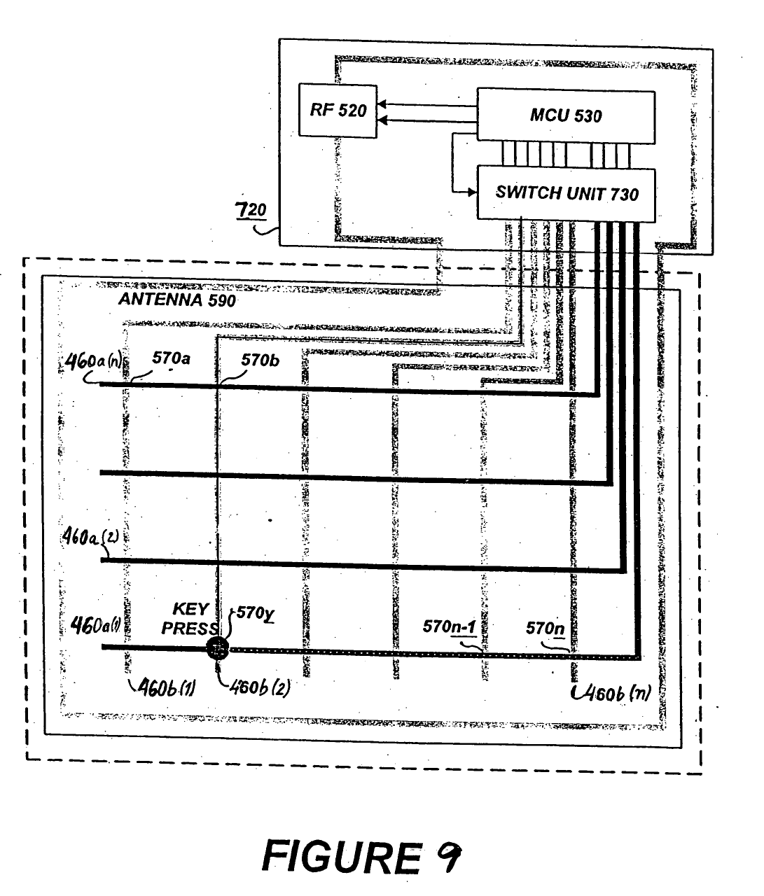

FIG. 9 illustrates the portion of the keyswitch matrix system 315 coupled with a controller unit 720 within a wireless keyboard 110 in accordance with one embodiment of the present invention. The controller unit 720 can include or be coupled to an RF unit 520. The controller unit includes a micro controller unit (“MCU”) 530 and a switch unit 730. The MCU 530 couples with the RF unit 520 and the switch unit 730. The switch unit 730 also couples with the rows 460a and/or the columns 460b in the electrical matrix 460 of the keyswitch matrix subsystem 315. The RF unit 520 also couples with the antenna 490.

The switch unit 730 may be comprised of hardware, software (e.g., firmware), or a combination thereof. The switch unit 730 is configured to control whether the RF unit 520 can load the antenna 490 or to control whether the MCU 530 can scan the electrical matrix 460. In this embodiment, the switch unit 730 is configured to keep the RF unit 520 in an OFF (or STANDBY or SLEEP) state when the MCU 530 is scanning the electrical matrix 460 and is configured to disconnect the electrical matrix 460 when the RF unit 520 is in an ON (including WAKE or START) state.

In one embodiment as illustrated in FIG. 9, if a key 215y is pressed on the RF keyboard 110, the MCU 530 and the switch unit 730 will not turn on the RF unit 520 to load the antenna 490. In this embodiment, the circuit in the electrical matrix 460 is closed with the coupling of the corresponding row 460a and column 460b at the switch point 570y associated with the pressed key 215y. The electrical current from the closed circuit that is formed passes through the switch unit 730 to the MCU 530.

The mechanism shown in FIG. 9 can optionally be used to prevent the spurious loop that may result from pressing a key and coupling a particular row 460a and column 460b at a switch point 570. This spurious loop is broken (or cancelled) through switch unit 730. Hence, there is no need to wait for a release of the depressed key before turning ON the RF unit 520 and loading the antenna 490. Therefore when the MCU 530 detects a depressed key 215 (or key change), the MCU 530 disconnects the electrical matrix 460, and turns ON the RF unit 520. The RF unit 520 loads the antenna 490 for transmission of the RF signals. The MCU 530 then restores connection to the electrical matrix 460 and resumes scanning the electrical matrix 460 to determine the next depressing of a key 215.

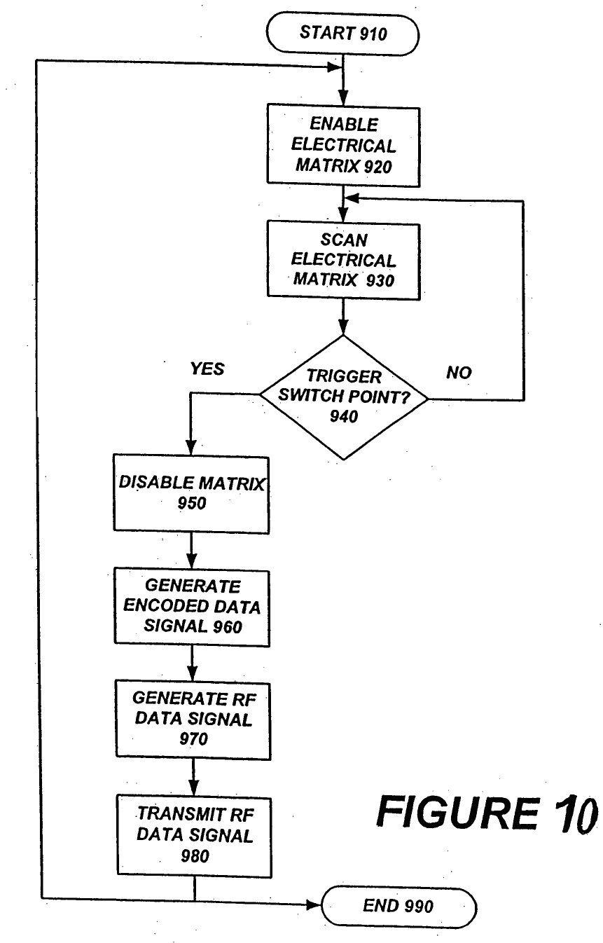

FIG. 10 illustrates one embodiment of a process for transmitting radio frequency signals in accordance with the present invention. For ease of discussion the process will be described with reference to the MCU 530, the RF unit 520, and the electrical matrix 460 described previously.

The process starts 910 and with the switch unit 730 and electrical matrix 460 of the keyswitch matrix subsystem 315 enabled (or connected) 920 to accept input from a user through the keys 215 of the RF keyboard 110. The MCU 530 scans 930 the electrical matrix 460 for a change to occur (e.g., through continuity closing of an open electrical circuit, an additional key 215 press, or a key 215 release). More particularly, the MCU 530 scans 930 the electrical matrix 460 to determine 940 that no switch points 570 are triggered. As long as the process continues to determine 940 if any switch points 570 are triggered, the MCU 530 continues to scan 930 the electrical matrix 460.

When the MCU 530 determines 940 that one switch point 570 is triggered, the MCU 530 disables (or disconnects) 950 the electrical matrix 460. Information relating to the changed key 215 state is sent to the RF unit 520 with as little delay as possible such that is appears instantaneous, i.e., at substantially the same time. More particularly, in one embodiment, the electrical matrix 460 may be disabled through a switch subsystem, for example, the switch unit 730 described previously. The MCU 530 generates 960 an encoded data signal that prepares the information for wireless transmission. The MCU 530 turns ON the RF unit 520 and sends the encoded data signal to the RF unit 520. Using an RF modulation scheme, the RF unit 520 generates 970 an RF data signal (or RF signal) from the enclosed data signal and loads the antenna of the antenna 490. The RF signal is then transmitted 980 for reception at a transceiver or a receiver associated with the host computer system 120. The process then allows the MCU 530 to once again enable 920 the electrical matrix 460 through the switch unit 730 or the process ends 990.

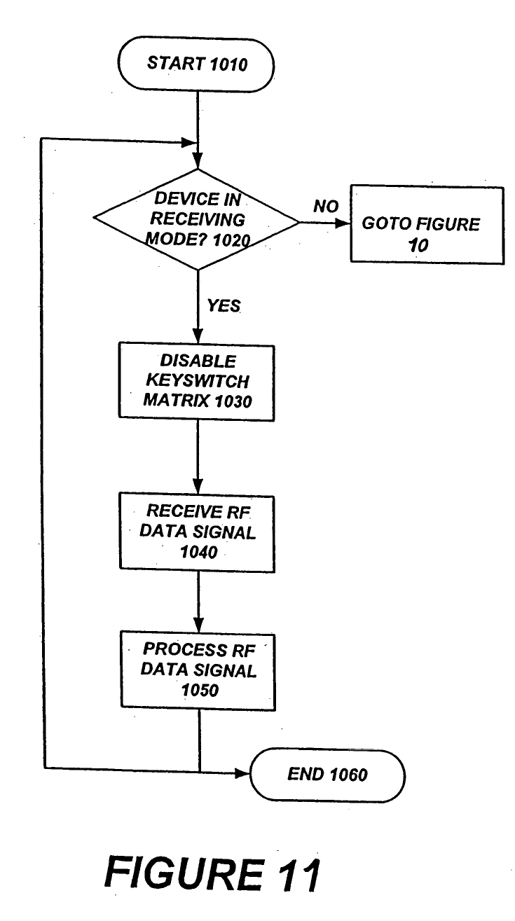

FIG. 11 illustrates one embodiment of a process for receiving radio frequency signals in accordance with the present invention. For ease of discussion the process will be described with reference to the MCU 530, the RF unit 520, and the electrical matrix 460 described previously.

At the start 1010 of the process, the MCU 530 determines 1020 whether the RF keyboard 110 is operating in a receiving mode. If it is not operating in a receiving mode, it may be operating in a transmission mode as described with regard to FIG. 9. If the RF keyboard 110 is operating in a receiving mode, the MCU 530 disables 1030 the electrical matrix 460 of the keyswitch matrix subsystem 315 and turns ON the RF unit 520.

The RF unit 520 receives RF signals (or RF data signals) 1040 that caused the appropriate electromagnetic disturbance (e.g., electrical current) in the antenna 490 after being transmitted by a transmitting device, for example, a transceiver associated with the host computer system 120. The RF unit 520 and the MCU 530 then appropriately process 1050 the received RF signals. The process then continues with the MCU 530 turning the RF unit 520 to an OFF state (e.g., putting the RF unit 520 in a STANDBY state) and once again enabling the electrical matrix 460. The process may then go back to determining whether the RF keyboard 110 is in a receiving mode. Alternatively, the process ends 1060.

The present invention offers flexibility to operate the RF keyboard in various modes including as a device that is dedicated to just transmit data. In an alternative embodiment, the RF keyboard 110 may alternate between a receive (or Rx) mode and a transmission (or. Tx) mode to handshake data and allow for a background scanning of the keyswitch matrix 315. In yet another embodiment, the RF keyboard may be configured to transmit and/or receive at predetermined intervals.

The present invention advantageously incorporates an antenna 490 at least partially in a metallized membrane 321 by printing, coating, or otherwise depositing conductive ink on the metallized membrane 321 forming a desirable geometric shape, such as, planes, loops, grids, spirals, dipoles, and other shapes used to change or improve the operating parameters of the particular antenna formed. For example, an antenna 490 is included within the layers of a membrane keyswitch matrix 315 for an RF keyboard 110. This provides a benefit of providing a low cost high performance antennas, by printing the antenna in a loop configuration that may be configured to provide a large antenna loop for the antenna. The large antenna loop allows for efficiently using a lower frequency communication circuit, e.g., an RF transmitter and/or receiver operating at 27 MHz, within the cordless device, e.g., keyboard, mouse, keypad, personal digital assistant, camera, or the like. The lower frequency communication circuit helps reduce power consumption, helps increase battery life, and helps reduce design and manufacturing costs for the cordless device. The higher efficiency increases the operational flexibility and freedom that is limited by lower frequency communication circuits.

While particular embodiments and applications of the present invention have been illustrated and described, it is to be understood that the invention is not limited to the precise embodiments disclosed herein. One of skill in the art will readily recognize from the following discussion that alternative embodiments of the structures and methods disclosed herein may be employed without departing from the principles of the present invention disclosed herein. These modifications and variations may be made in the arrangement, operation and details of the method and apparatus of the present invention disclosed herein without departing from the spirit and scope of the invention as defined in the appended claims.

What is claimed is:

1. An apparatus for use in a cordless device, comprising:
an antenna component configured to couple to a radio transmitter, the antenna component further configured for electromagnetic propagation of a signal from the radio transmitter; and
a metallized membrane of a keyswitch matrix system, the metallized membrane having a surface that comprises a first geometric shape printed with conductive ink, the first geometric shape configured to couple with the antenna component.

2. The apparatus of claim 1, wherein the first geometric shape printed on the metallized membrane comprises a ground plane.

3. The apparatus of claim 1, wherein the antenna component is configured to form an antenna loop.

4. The apparatus of claim 1, wherein the signal corresponds to a pressing of a key, the signal being generated in the keyswitch matrix system by conductive traces electrically coupling upon the pressing of the key.

5. The apparatus of claim 1, wherein the metallized membrane is one of a top, a middle, or a bottom membrane in a three layer keyswitch matrix system.

6. The apparatus of claim 1, further comprising a second metallized Membrane having a second geometric shape printed with conductive ink, the second geometric shape coupled to the first geometric shape and configured to form at least part of an antenna.

7. The apparatus of claim 1, wherein the cordless device is one of a keyboard, a mouse, a digital camera, a joystick, or a game pad.

8. An apparatus for use in a cordless device, comprising:
means for propagating electromagnetic energy through coupling to a radio transmitter; and
means for electrically grounding configured to couple to a radio frequency transmission system, the means for electrically grounding printed on a membrane of a keyswitch matrix system and coupled to the means for propagating.

9. The apparatus of claim 8, wherein the means for propagating is configured to from a loop antenna.

10. The apparatus of claim 8, wherein the radio frequency transmission system comprises one of a transmitter, a receiver, or a transceiver.

11. The apparatus of claim 8, wherein the keyswitch matrix system is within one of a keyboard, a mouse, a digital camera, a joystick, or a game pad.

12. A method of manufacturing antenna components on a membrane keyswitch assembly having a plurality of membranes, the method comprising:
printing with an electrically conductive printing substance a geometric shape on a surface of one of the plurality of membranes, the geometric shape forming a ground plane; and
electrically coupling the printed geometric shape with one or more antenna components.

13. The method of claim 12, wherein the printing includes one of screen printing, ink jet printing, and laser printing.

14. The method of claim 12, wherein the electrically conductive printing substance is a metallic ink.

15. The method of claim 12, wherein the geometric shape is one of a, grid, or a continuous polygonal surface.
